(19) United States
(12) Patent Application Publication
(10) Pub. No.: US 2025/0219270 A1
(43) Pub. Date: Jul. 3, 2025

(54) ALL-SOLID-STATE RECHARGEABLE BATTERY, STACKED ALL-SOLID-STATE RECHARGEABLE BATTERY

(71) Applicant: SAMSUNG SDI CO., LTD., Yongin-si, Gyeonggi-do (KR)

(72) Inventors: Ryo OMODA, Yokohama-shi (JP); Hiroe ISHIHARA, Yokohama-shi (JP); Hiroshi KIMURA, Yokohama-shi (JP); Yohei HAMAGUCHI, Yokohama-shi (JP)

(21) Appl. No.: 18/850,988

(22) PCT Filed: Mar. 31, 2023
(86) PCT No.: PCT/KR2023/004341

§ 371 Date: Sep. 25, 2024

(30) Foreign Application Priority Data
Mar. 31, 2022 (JP) 2022-060995
Mar. 30, 2023 (KR) 10-2023-0042327

(51) Int. Cl. H01M 50/586; H01M 10/0525; H01M 10/0562; H01M 10/42

(52) U.S. Cl. CPC H01M 50/586; H01M 10/0525; H01M 10/0562; H01M 10/4235

(57) ABSTRACT

An all-solid-state rechargeable battery capable of preventing generation of short circuits may be provided by securely disposing the positive electrode current collector in the desired position as much as possible or by detecting an arrangement issue of the positive electrode current collector in an early stage of manufacturing process. an all-solid-state rechargeable battery according to an embodiment includes a positive electrode layer, a negative electrode layer, a solid electrolyte layer disposed therebetween, and an insulating layer configured to suppress short-circuiting caused by contact between the positive electrode layer and the negative electrode layer, where the solid electrolyte layer is stacked on both surfaces of the positive electrode layer, respectively, the negative electrode layer is stacked on a surface of the respective solid electrolyte layer on an opposite side to the positive electrode layer, respectively, and the insulating layer is disposed on a side cross-section of the positive electrode layer to cover the positive electrode layer, where the positive electrode layer comprises a thin positive electrode current collector and a positive active material layer stacked on both surfaces of the positive electrode current collector, respectively, and where the insulating layer enables a position of an outer edge of the positive electrode current collector covered by the insulating layer to be optically identifiable through the insulating layer.

### TECHNICAL FIELD

The present invention relates to all-solid-state rechargeable battery and stacked all-solid-state rechargeable battery.

### BACKGROUND ART

For the purpose of good cycle characteristics and suppressing generation of short circuit, in an all-solid-state rechargeable battery in the shape that two sheets of solid electrolyte layers are stacked on both surfaces of a positive electrode layer, and the two sheets of solid electrolyte layers are inserted between two sheets of the negative electrode layers disposed on outer sides, an all-solid-state rechargeable battery, which reduces protrusions and depressions in the thickness direction through isostatic pressing, has been proposed (Patent Document 1).

To further suppress short circuits in the all-solid-state rechargeable battery described in Patent Document 1, it is proposed to dispose an insulating layer on the cross-section of the positive electrode layer side to cover the positive electrode layer.

### PRIOR ART DOCUMENT

### Patent Document

(Patent Document 1) Japanese Patent Laid-Open Publication No. 2019-121558

### DISCLOSURE

### Technical Problem

Despite the present inventor conducting extensive research to sufficiently suppress short circuits in the above-described all-solid-state rechargeable battery, it was found that performance tests on the manufactured all-solid-state rechargeable battery occasionally still resulted in the generation of short circuits.

The present inventor, after repeatedly examining the cause of short circuits in the above-described all-solid-state rechargeable battery, concluded that the issue might be due to the position of the thin positive electrode current collector provided in the positive electrode layer being misaligned from the desired position or due to undetected defects arising during the battery manufacturing process and persisting until the final stages.

In the former case, in an all-solid-state rechargeable battery where lithium precipitates in the negative electrode layer and the precipitated lithium is used as the negative active material, lithium may precipitate in the same shape as the positive electrode current collector at a position in the negative electrode layer corresponding to the positive electrode current collector.

Accordingly, in such an all-solid-state rechargeable battery, if the positive electrode current collector is disposed at an unintended location, lithium may precipitate at an unintended location in the negative electrode layer, and this causes the precipitation of lithium in the negative electrode to become non-uniform, increasing the risk of a short circuit.

In the latter case, if a current collecting film or other battery member inside the battery develops unexpected fractures or cracks during the manufacturing process, these defects may go unnoticed both visually and electrochemically, and consequently, issues may only be discovered after the cell has been manufactured.

Therefore, in the manufacturing process of the above-described all-solid-state rechargeable battery that includes the insulating layer, the arrangement of materials is adjusted to ensure that the positive electrode layer and the insulating layer have the desired positional relationship, and after this adjustment, the materials are pressurized to form the insulating layer. In addition, by adjusting this arrangement, it was thought that the positive electrode current collector would be disposed in the position intended by the manufacturer.

However, the present inventor considered that, contrary to common assumptions, there might be rare cases where the position of the positive electrode current collector shifts inside the positive electrode layer during pressurization, or where a portion of the positive electrode current collector becomes bent.

Even if the positive electrode current collector is disposed in a position other than intended, since opaque resin materials are traditionally used as the insulating layer materials, when the side cross-section of the positive electrode layer is once covered by the insulating layer, it becomes impossible to further confirm the position of the positive electrode current collector.

Therefore, if the position of the positive electrode current collector deviates from the intended position without being noticed, the assembly of the all-solid-state rechargeable battery proceeds, and it is only during the performance testing of the completed battery that the problem is first discovered.

The present invention, conducted in consideration of the above technical object, aims to provide an all-solid-state rechargeable battery, where an insulating layer is disposed to cover the positive electrode layer in its side cross-section, capable of enabling the positive electrode current collector to be disposed as securely as possible at the desired position, or facilitating early detection during the manufacturing steps to prevent the generation of short circuits, in cases where there are issues with the arrangement of the positive electrode current collector.

### Technical Solution

That is, an all-solid-state rechargeable battery according to the present invention includes a positive electrode layer, a negative electrode layer, a solid electrolyte layer disposed therebetween, and an insulating layer configured to suppress short-circuiting caused by contact between the positive electrode layer and the negative electrode layer.

The solid electrolyte layer is stacked on both surfaces of the positive electrode layer, respectively, the negative electrode layer is stacked on a surface of the respective solid electrolyte layer on an opposite side to the positive electrode layer, respectively, and the insulating layer is disposed on a side cross-section of the positive electrode layer to cover the positive electrode layer.

The positive electrode layer comprises a thin positive electrode current collector and a positive active material layer stacked on both surfaces of the positive electrode current collector, respectively.

The insulating layer enables a position of an outer edge of the positive electrode current collector covered by the insulating layer to be optically identifiable through the insulating layer.

According to an all-solid-state rechargeable battery configure as described above, it is possible to visually inspect the side cross-section of the positive electrode current collector from the outside, even after covering the side cross-section of the positive electrode layer by the insulating layer. As a result, when manufacturing an all-solid-state rechargeable battery by stacking a solid electrolyte and a negative active material layer on the positive electrode layer, the positive electrode current collector can be securely disposed at the desired position in the all-solid-state rechargeable battery.

In addition, it is possible to detect issues such as misalignment of position or bending of the positive electrode current collector from the outside of the insulating layer through visual inspection, and therefore, if problems are found in the positive electrode layer after attaching the insulating layer, a determination can be made not to use that positive electrode layer in the assembly of the all-solid-state rechargeable battery.

As a result, it is possible to manufacture an all-solid-state rechargeable battery with minimal issues.

As a specific embodiment of the present invention, a total light transmittance of the insulating layer may be 25% or more.

As a specific embodiment of the present invention, a linear light transmittance of the insulating layer at at least one wavelength in a wavelength range of 400 nm or more and 800 nm or less is 20% or more of a value calculated based on an insulating layer thickness of 100 μm.

In the case that the positive electrode layer includes the positive electrode current collector and a positive active material layer formed on both surfaces of the positive electrode current collector, and an exterior circumference edge of the positive electrode current collector protrudes outward beyond a side cross-section of the positive active material layer, it is easily to detect wrinkles in the positive electrode current collector, or bending of the positive electrode current collector, which is thereby preferable.

As a specific embodiment of the present invention, the insulating layer may contain a resin, and have a volume resistivity of 10¹² Ω/cm or more.

As a specific embodiment, it is preferable if the insulating layer is made of resin or contains resin.

If the insulating layer further contains an insulative filler, the insulative filler can improve the close contact between the materials forming the insulating layer, thereby enhancing the strength of the insulating layer.

As the insulative filler, one or more materials selected from a group consisting of fibrous resin, resin non-woven fabric, alumina, magnesium oxide, silica, boehmite, barium titanate, carbonate barium, yttrium oxide and manganese oxide may be used.

If the positive electrode current collector is provided with a positive electrode current collecting portion to be electrically connected to an external wire, the positive electrode current collecting portion is installed to laterally protrudes along a surface of the positive electrode current collector, and a part or all of an outer edge of the insulating layer on the protruding side of the current collecting portion is located on an outer side of an outer edge of the negative electrode layer, suppress short-circuiting caused by physical contact between the positive electrode layer and the negative electrode layer, which is thereby preferable.

In order to suppress the short-circuit between the positive electrode layer and the negative electrode layer, it is preferable if a part or all of the outer edge of the negative electrode layer is disposed on the insulating layer.

If the solid electrolyte layer contains a sulfide-based solid electrolyte including at least lithium, phosphorus, and sulfur, the battery performance of the all-solid-state rechargeable battery may be improved, which is thereby preferable.

It is preferable if the negative electrode layer includes a negative active material forming an alloy with lithium and/or a negative active material forming a compound with lithium, metal lithium may precipitate inside the negative electrode layer during charging, and 80% or more of the charge capacity of the negative electrode layer is exerted by metal lithium.

As a specific embodiment of the present invention, the negative electrode layer may include one type or more selected from a group consisting of amorphous carbon, gold, platinum, palladium, silicon, silver, aluminum, bismuth, tin and zinc.

If the all-solid-state rechargeable battery according to the present invention is stacked by two or more quantity to form a stacked all-solid-state rechargeable battery, for example, the localized precipitation of lithium in all-solid-state rechargeable battery that precipitate lithium in the negative electrode layer may be suppressed as much as possible, and short circuits may be more difficult to occur in the stacked all-solid-state rechargeable battery.

### Advantageous Effects

According to the present invention, in a battery where an insulating layer is disposed on a side cross-section of the positive electrode layer to cover the positive electrode layer, the positive electrode current collector can be more securely positioned at the desired location.

In addition, if the positive electrode current collector is not positioned at the desired location or if defects occur in the positive electrode current collector, these can be detected before the final process of battery manufacturing, thereby minimizing the occurrence of defective batteries and preventing potential short circuits caused by battery defects.

When a stacked all-solid-state rechargeable battery is formed by stacking two or more all-solid-state rechargeable batteries according to the present invention, the arrangement of the positive electrode current collector may be aligned as much as possible over the entire stacked all-solid-state rechargeable battery. As a result, in a stacked all-solid-state rechargeable battery where lithium is precipitated in the negative electrode layer, the position in each all-solid-state rechargeable battery where lithium precipitated may be aligned. As a result, the thickness change over the entirety of the stacked all-solid-state rechargeable battery during charging and discharging may become uniform as much as possible, the short circuits may be more difficult to occur in the stacked all-solid-state rechargeable battery.

### DESCRIPTION OF THE DRAWINGS

FIG. 1 is a cross-sectional view showing a schematic configuration of an all-solid-state rechargeable battery according to an embodiment of the present invention.

FIG. 2 is an enlarged cross-sectional view showing a schematic configuration of an all-solid-state rechargeable battery according to the present embodiment.

FIG. 3 is an enlarged top plan view showing a schematic configuration of an all-solid-state rechargeable battery according to the present embodiment.

FIG. 4 is a schematic view showing a manufacturing method of an all-solid-state rechargeable battery according to the present embodiment.

FIG. 5 is a top plan view of the laminate of FIG. 4(b) according to a stacking direction.

FIG. 6 is a schematic view showing the structure of a surplus insulating layer material used in an all-solid-state rechargeable battery according to the present embodiment. FIG. 6(a) is a top plan view according to a stacking direction, and FIG. 6(b) is a cross-sectional view taken along line B-B.

FIG. 7 is a schematic view showing a manufacturing method of an all-solid-state rechargeable battery according to the present embodiment.

FIG. 8 is a schematic view showing a manufacturing method of an all-solid-state rechargeable battery according to the present embodiment.

FIG. 9 is a schematic view showing a manufacturing method of an all-solid-state rechargeable battery according to the present embodiment.

FIG. 10 is a graph showing evaluation results of an all-solid-state rechargeable battery according to an embodiment.

FIG. 11 is a graph showing evaluation results of an all-solid-state rechargeable battery according to an embodiment.

FIG. 12 is a graph showing evaluation results of an all-solid-state rechargeable battery according to an embodiment.

FIG. 13 is a graph showing evaluation results of an all-solid-state rechargeable battery according to an embodiment.

FIG. 14 is a graph showing evaluation results of an all-solid-state rechargeable battery according to an embodiment.

FIG. 15 is a graph showing evaluation results of an all-solid-state rechargeable battery according to an embodiment.

FIG. 16 is a graph showing evaluation results of an all-solid-state rechargeable battery according to an embodiment.

FIG. 17 is a graph showing evaluation results of an all-solid-state rechargeable battery according to a Comparative Example of the present invention.

FIG. 18 is a graph showing evaluation results of an all-solid-state rechargeable battery according to a Comparative Example of the present invention.

FIG. 19 is a graph showing evaluation results of an all-solid-state rechargeable battery according to a Comparative Example of the present invention.

FIG. 20 is a graph showing evaluation results of an all-solid-state rechargeable battery according to a Comparative Example of the present invention.

### MODE FOR INVENTION

Hereinafter, preferred embodiments of the present invention will be described in detail with reference to the accompanying drawings. Meanwhile, in this specification and drawing, components having substantially the same functional configuration are given the same reference numerals, thereby omitting redundant description. In addition, each component in the drawings is appropriately enlarged or reduced for ease of explanation, and the size and ratio of each component in the drawings may be different from the actual ones.

### 1. Basic Configuration of an all-Solid-State Rechargeable Battery According to Present Embodiment

First, a configuration of an all-solid-state rechargeable battery 1 according to an embodiment of the present invention will be described.

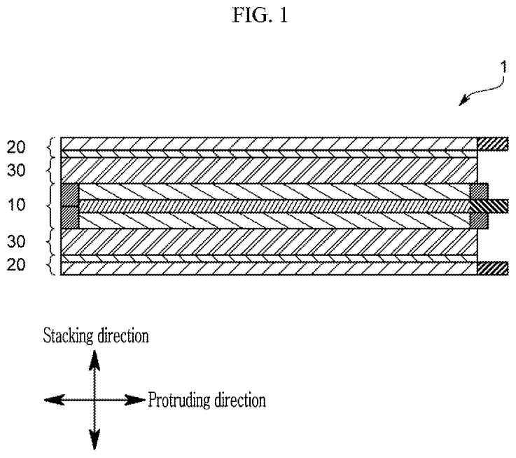

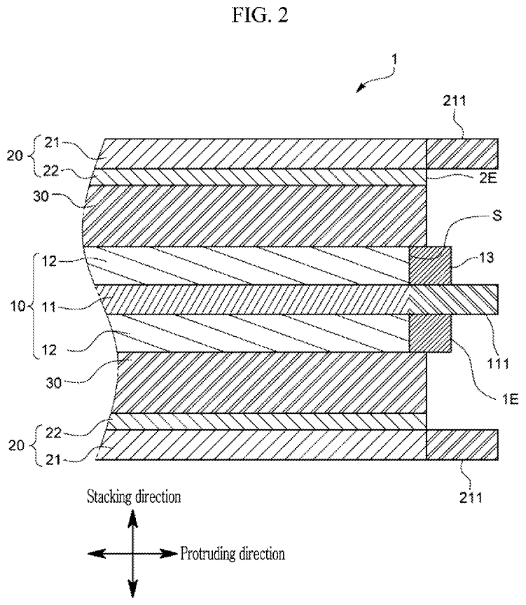

The all-solid-state rechargeable battery 1 according to the present embodiment is provided with, for example, as shown in FIG. 1 and FIG. 2, a positive electrode layer 10, a negative electrode layer 20, and a solid electrolyte layer 30. More specifically, it is an all-solid-state lithium rechargeable battery provided with the positive electrode layer 10, the solid electrolyte layer 30 stacked on both surfaces of the positive electrode layer 10, respectively, the negative electrode layer 20 stacked on a surface of the respective solid electrolyte layer 30 on an opposite side to the positive electrode layer 10, respectively, and an insulating layer 13 disposed in a side cross-section S of the positive electrode layer 10. Meanwhile, the side cross-section refers to the surrounding end portion, which is not in the stacking direction of the respective layers, and it means the end portion of the respective layers in a direction perpendicular to the stacking direction.

### (1-1. Positive Electrode Layer)

As shown in FIG. 2, the positive electrode layer 10 may include a positive electrode current collector 11 and a positive active material layer 12.

As the positive electrode current collector 11, for example, a plate or thin sheet made of stainless steel, titanium (Ti), nickel (Ni), aluminum (Al), or an alloy thereof can be used. A thickness of the positive electrode current collector 11 may be, for example, 1 μm or more and 50 μm or less, more preferably 5 μm or more and 30 μm or less.

As shown in FIG. 2, the positive active material layer 12 is disposed on both surfaces of the positive electrode current collector 11. The positive active material layer 12 may contain at least positive active material and solid electrolyte.

The solid electrolyte contained in the positive active material layer 12 may and may not be the same type as the solid electrolyte contained in the solid electrolyte layer 30. Details of the solid electrolyte will be described later in the description of the solid electrolyte layer 30.

The positive active material may be a positive active material capable of reversibly intercalating and discharging lithium ions.

For example, the positive active material may be in the form of powder or particles, and may be formed by using a lithium salt, such as lithium cobalt oxide (hereinafter, referred to as LCO), lithium nickel oxide, lithium nickel cobalt oxide, lithium nickel cobalt aluminum oxide (hereinafter, referred to as NCA), lithium nickel cobalt manganese oxide (hereinafter, referred to as NCM), lithium manganate, lithium iron phosphate, nickel sulfide, copper sulfide, sulfur, iron oxide, or vanadium oxide. These positive active materials may be used each individually, and they may also be used in combination of two types or more.

In addition, it is preferable if the positive active material is formed by including a lithium salt of a transition metal oxide, which has a layered rock salt structure, among the above-described lithium salts. Here, the term “layered” refers to a thin sheet-like shape. In addition, the term “rock salt structure” represents a sodium chloride structure, which is a type of crystal structure, and specifically, this represents a structure where the face-centered cubic lattice formed by each of positive and negative ions is misaligned by half of the edge of the unit lattice.

Examples of lithium salts of transition metal oxides that have a layered rock salt structure like this include, for example, lithium salts of ternary transition metal oxide such as LiNiₓCo_{y}Al_{z}O₂ (NCA), or LiNiₓCo_{y}Mn_{z}O₂ (NCM) (where, 0<x<1, 0<y<1, 0<z<1, and x+y+z=1).

When the positive active material includes the lithium salt of ternary transition metal oxide having the above-described layered rock salt structure, the energy density and thermal stability of the all-solid-state rechargeable battery 1 may be improved.

The positive active material may be covered by a cladding layer on its surface. Here, the coating layer of this embodiment may be any one as long as it is known as a coating layer of the positive electrode active material of the all-solid-state secondary battery 1. Examples of the cladding layer may include, for example, Li₂O—ZrO₂, or the like.

In addition, when the positive active material is formed of the lithium salt of ternary transition metal oxide such as NCA or NCM, and contains nickel (Ni) as the positive active material, a capacity density of the all-solid-state rechargeable battery 1 may be increased, and metal elution from the positive active material in the charged state may be reduced. Accordingly, the all-solid-state rechargeable battery 1 according to the present embodiment may improve the long-term reliability and cycle characteristics in the charged state.

Here, examples of the shape of the positive electrode active material include granular shapes such as true spheres and elliptical spheres. In addition, the particle diameter of the positive active material is not particularly limited, and it may be within the range applicable to the positive active material of a conventional all-solid-state rechargeable battery. Meanwhile, the content of the positive active material in the positive electrode layer 10 is not particularly limited, and may be in the range applicable to the conventional positive electrode layer 10 of the all-solid-state rechargeable battery 1.

In addition, the positive active material layer 12 may appropriately be mixed with additives such as conductive aid, binder, fillers, dispersants, and ion conduction aids, in addition to the above-described positive active material and solid electrolyte.

The conductive aid that can be mixed into the positive active material layer 12 includes, for example, graphite, carbon black, acetylene black, Ketjen black, carbon fiber, carbon nanotube, graphene, metal powder. In addition, examples of binders that can be mixed into the positive active material layer 12 include, for example, styrene-butadiene rubber (SBR), polytetrafluoroethylene, polyvinylidene fluoride, and polyethylene. In addition, fillers, dispersants, and ion conduction aids that can be mixed into the positive active material layer 12 may generally use the material disclosed for use in the electrode of the all-solid-state rechargeable battery 1.

Although the thickness of the positive active material layer 12 in a state in the completed battery is not particularly limited, it may preferably be, for example, 20 μm or more and 1000 μm or less, and more preferably, 50 μm or more and 500 μm or less, and particularly preferably 100 μm or more and 300 μm or less.

### (1-2. Negative Electrode Layer)

For example, as shown in FIG. 2, the negative electrode layer 20 may include a plate-shaped or thin negative electrode current collector 21, and a negative active material layer 22 formed on the negative electrode current collector 21.

In the present embodiment, the negative electrode current collector 21 may form the outermost layer of the all-solid-state rechargeable battery 1.

The negative electrode current collector 21 is preferably configured with a material that does not react with lithium, in other words, does not form any alloy or compound.

The material for configuring the negative electrode current collector 21 may be, for example, not only stainless but also copper (Cu), titanium (Ti), iron (Fe), cobalt (Co), nickel (Ni), and the like.

The negative electrode current collector 21 may be configured of any one type of these metals, and it may also be configured of an alloy of two or more types of metals or a clad material.

A thickness of the negative electrode current collector 21 may be, for example, 1 μm or more and 50 μm or less, more preferably 5 μm or more and 30 μm or less.

For example, the negative active material layer 22 may include at least one among a negative active material forming an alloy with lithium and a negative active material forming a compound with lithium. In addition, the negative active material layer 22, containing such a negative active material, may be configured to allow the precipitation of metal lithium on the first side or both side surfaces of the negative active material layer 22, as explained below.

For example, the negative active material may include amorphous carbon, gold, platinum, palladium (Pd), silicon (Si), silver, aluminum (Al), bismuth (Bi), tin, antimony, zinc, and the like.

Here, examples of the amorphous carbon can include carbon blacks such as acetylene black, furnace black, Ketjen black, or graphene, etc.

The shape of the negative active material may not be particularly limited, and may be a granular shape, and for example, it may also be in the form of a uniform layer such as a plating layer.

In the case of the former, lithium ions or lithium may pass through the interior of the granular-shaped negative active material, or the gap between the negative active materials, forming a metal layer principally composed of lithium between the negative active material layer 22 and the negative electrode current collector 21, and some lithium may exist within the negative active material layer 22, possibly forming an alloy with the metal element inside the negative active material.

Meanwhile, in the case of the latter, the metal layer may be precipitated between the negative active material layer 22 and the solid electrolyte layer 30.

Among those described above, it is preferable that, the negative active material layer 22 includes, as the amorphous carbon, a mixture of a low specific surface area amorphous carbon, of which the specific surface area measured by the nitrogen gas adsorption method is 100 m²/g or less, and a high specific surface area amorphous carbon, of which the specific surface area measured by the nitrogen gas adsorption method is 300 m²/g or more.

The negative active material layer 22 may contain only one type of the negative active materials, and it may also contain two types or more of negative active materials. For example, the negative active material layer 22 may contain only amorphous carbon as the negative active material, and may also contain one type or more selected from a group consisting of gold, platinum, palladium, silicon, silver, aluminum, bismuth, tin, antimony, and zinc. In addition, the negative active material layer 22 may contain a mixture of one type or more selected from a group consisting of gold, platinum, palladium, silicon, silver, aluminum, bismuth, tin, antimony, and zinc, and amorphous carbon.

The mixing ratio (mass ratio) of the mixture of amorphous carbon and the above-described gold or other metals is preferably about 1:1 to 1:3, and by configuring the negative active material with these materials, the characteristics of the all-solid-state rechargeable battery 1 may be further improved.

In the case of using one type or more selected from a group consisting of gold, platinum, palladium, silicon, silver, aluminum, bismuth, tin, antimony, and zinc, along with amorphous carbon, as the negative active material, it is preferable if the particle diameter of these negative active materials is 4 μm or less. In this case, the characteristics of the all-solid-state rechargeable battery 1 may be further improved.

In addition, when a material capable of forming an alloy with lithium, such as one type or more selected from a group consisting of gold, platinum, palladium, silicon, silver, aluminum, bismuth, tin, antimony and zinc, is used as the negative active material, the negative active material layer 22 may also be a layer made of these metals. For example, this layer of metal may also be a plating layer.

If necessary, the negative active material layer 22 may further include a binder. Examples of this binder may include styrene-butadiene rubber (SBR), polytetrafluoroethylene (PTFE), polyvinylidene fluoride, and polyethylene oxide. The binder may be configured as one type of these, and it may also be configured as two types or more. Therefore, by including the binder in the negative active material layer 22, particularly when the negative active material is in the granular shape, it may suppress the detachment of the negative active material. The content of the binder contained in the negative active material layer 22, with respect to the total mass of the negative active material layer 22, may be, for example, 0.3 mass % or more and 20.0 mass % or less, preferably 1.0 mass % or more and 15.0 mass % or less, and more preferably 3.0 mass % or more and 15.0 mass % or less.

In addition, the negative active material layer 22 may appropriately be mixed with additives used in the conventional all-solid-state rechargeable battery 1, for example, fillers, dispersing materials, ion conductive materials, etc.

The thickness of the negative active material layer 22 is not particularly limited, but when the negative active material is in a granular shape, the thickness in the completed state as a battery may be, for example, 1 μm or more and 30 μm or less, preferably 5 μm or more and 20 μm or less. By maintaining such a thickness, it is possible to sufficiently achieve the above-described effect of the negative active material layer 22, while sufficiently reducing the resistance of the negative active material layer 22, which may significantly improve the characteristics of the all-solid-state rechargeable battery 1.

Meanwhile, the thickness of the negative active material layer 22 may be, for example, from 1 nm to 100 nm when the negative active material forms a uniform layer. In this case, the upper limit value of the thickness of the negative active material layer 22 may be, preferably 95 nm, more preferably 90 nm, and even more preferably 50 nm.

Meanwhile, the present invention is not limited to the above-described embodiment, the negative active material layer 22 can adopt any configuration usable as the negative active material layer 22 of the all-solid-state rechargeable battery 1.

For example, the negative active material layer 22 may be a layer that includes the above-described negative active material, solid electrolyte, and negative electrode layer conductive aid.

In this case, for instance, a metal active material or a carbon active material may be used as the negative active material. As the metal active material, for example, metals such as lithium (Li), indium (In), aluminum (Al), tin (Sn), and silicon (Si), and their alloys, may be used. In addition, as active carbon materials, for example, artificial graphite, graphite carbon fiber, resin-calcined carbon, pyrolytic vapor-grown carbon, coke, mesocarbon microbeads (MCMB), furfuryl alcohol resin-calcined carbon, polyacene, pitch-based carbon fiber, vapor-grown carbon fiber, natural graphite, and non-graphitizable carbon may be used. Meanwhile, their negative active material may be used alone, and it may also be used in combination with two types or more.

The negative electrode layer conductive aid and the solid electrolyte may use the same compound as the conductive agent and solid electrolyte included in the positive active material layer 12. Accordingly, the explanation about their configuration may be omitted here.

### (1-3. Solid Electrolyte Layer)

For example, as shown in FIG. 1 and FIG. 2, the solid electrolyte layer 30 may be a layer formed between the positive electrode layer 10 and the negative electrode layer 20, and may include a solid electrolyte.

In the present embodiment, the solid electrolyte layer 30 is stacked between the positive electrode layer 10 and the negative electrode layer 20.

The thickness of the solid electrolyte layer 30 may be 5 μm or more and 100 μm or less in the completed state of the battery. The thickness may preferably be 8 μm or more and 80 μm or less, and more preferably 10 μm or more and 50 μm or less.

For example, the solid electrolyte may be in the form of a powder, and for example, it may be configured from a sulfide-based solid electrolyte material.

Examples of the sulfide-based solid electrolyte material may include, Li₂S—P₂S₅, Li₂S—P₂S₅—LiX (X is a halogen element, for example, I, Br, CI), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive number, Z is one of Ge, Zn, or Ga), Li₂S—GeS₂, Li₂S—SiS₂—Li₃PO₄, Li₂S—SiS₂-LiₚMO_{q} (p and q are positive number, M is one of P, Si, Ge, B, Al, Ga or In). Here, the sulfide-based solid electrolyte material may be produced by treating the starting raw materials (e.g., Li₂S, P₂S₅, etc.) through methods such as the fusion quenching method or the mechanical milling method. In addition, heat treatment may be further performed after these processes. The solid electrolyte may be amorphous, may be crystalline, or may be in a mixed state of those.

In addition, as a solid electrolyte, it is preferable to use a material that contains one type or more elements selected from a group consisting of sulfur, silicon, phosphorus, and boron, from the above-described sulfide-based solid electrolyte materials. Accordingly, the lithium conductivity of the solid electrolyte layer 30 may be improved, and the battery characteristics of the all-solid-state rechargeable battery 1 may be improved. In particular, it may be preferable to use a solid electrolyte that includes at least sulfur(S), phosphorus (P), and lithium (Li) as configuration elements, and specifically, it is more preferable to use one that includes Li₂S—P₂S₅.

In the case of using one including Li₂S—P₂S₅ as a sulfide-based solid electrolyte material forming a solid electrolyte, the mixed mole ratio of Li₂S and P₂S₅ can be selected within the range of, for example, Li₂S:P₂S₅=50:50 to 90:10. In addition, the solid electrolyte layer 30 may further include a binder. The binder included in the solid electrolyte layer 30 can include, for example, styrene-butadiene rubber (SBR), polytetrafluoroethylene (PTFE), polyvinylidene fluoride (PVDF), polyethylene (PE), polyacrylic acid (PAA), etc. The binder included in the solid electrolyte layer 30 may be of the same type as or different type from the binder in the positive active material layer 12 and the negative active material layer 22.

### (1-4. Current Collecting Portion)

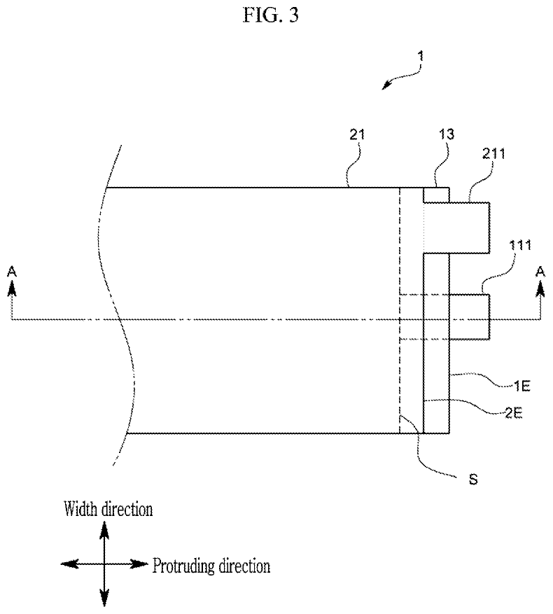

As shown in FIG. 2 and FIG. 3, the positive electrode current collector 11 may be provided with a positive electrode current collecting portion 111 that protrudes laterally, and an external wire is connected by interposing this positive electrode current collecting portion 111. In the same way, the negative electrode current collector 21 may be provided with a laterally protruding negative electrode current collecting portion 211, and an external wire is connected by interposing this negative electrode current collecting portion 211. Meanwhile, FIG. 3 may be a view of an all-solid-state rechargeable battery according to the present embodiment seen from the stacking direction, and FIG. 2 may be a cross-sectional view of this all-solid-state rechargeable battery taken along the A-A line in FIG. 3.

Meanwhile, in this specification, “side” may refer to a direction heading toward the outer side along the surface from the exterior circumference edge of, for example, the positive electrode current collector, and more specifically, it refers to a direction vertical to the stacking direction of respective layers configuring an all-solid-state rechargeable battery.

In the present embodiment, the positive electrode current collecting portion 111 may be configured to protrude towards the interior of the insulating layer 13. Meanwhile, for better understanding and ease of description, in each drawing, the direction in which the positive electrode current collecting portion 111 protrudes is referred to as the protruding direction, and the direction perpendicular to the protruding direction in the plane view of the respective layers that configure the all-solid-state rechargeable battery 1 in the stacking direction is referred to as the width direction.

Meanwhile, in the present embodiment, although the positive electrode current collecting portion 111 and the negative electrode current collecting portion 211 are almost parallel in the protruding direction and are also protruding at almost the same length, their protruding direction and protrude length may be the same or different.

### (1-5. Insulating Layer)

For example, the insulating layer 13 may be disposed in tight contact with the side cross-section S of the positive active material layer 12, so as to cover the entire side cross-section S of the positive active material layer 12 of the positive electrode layer 10. The insulating layer 13 might be formed using the insulating layer material 13A made of a material that does not allow electricity to pass through, and preferably, its volume resistivity is 10¹² Ω/cm or more. The material for configuring the insulating layer material 13A may include, for example, a resin film containing resins such as polypropylene, polyethylene, or their copolymer. As for resins, in addition to the polyolefin-based resin material mentioned above, vinyl-based resins such as polyvinyl chloride (PVC), polyacetal resin, acryl-based resins such as polymethyl methacrylate (PMMA), polycarbonate (PC), polyamide-based resin, polyurethane resin, fluorine-based resins such as polytetrafluoroethylene (PTFE), and also composite resins of those can also be used.

This type of resin film, for example, may be made difficult to peel off by applying tight contact to the positive electrode layer 10 through pressurization formation such as isostatic pressing. Furthermore, it would be more advantageous if the insulating layer material 13A is a mixture of the filler with insulating properties in their resin. As the insulating layer material 13A by contains the insulative filler, the close contacting property between the insulating layer materials 13A becomes better, and the strength of the insulating layer 13 during formation or use may be improved. In addition, the insulating layer material 13A may form fine protrusions and depressions on the surface of the insulating layer 13 by containing a filler with insulating property along with resin. It is also possible to make the solid electrolyte layer 30 less likely to peel off from the insulating layer 13 when stacking the solid electrolyte layer 30, depending on the shape of the protrusions and depressions on the surface of the insulating layer 13. The insulative filler may use various shapes such as granular shape, fiber type, droplet type or plate type. Among them, it is preferable to use fibrous or non-woven fabric type of insulative filler, which represents the effect particularly and significantly.

From the perspective of suppressing cost increase, as the insulative filler, for example, it is preferable if one or more materials selected from a group consisting of fibrous resin, resin non-woven fabric, alumina, magnesium oxide, silica, boehmite, barium titanate, carbonate barium, yttrium oxide and manganese oxide are used.

The thickness of the insulating layer 13 in the state completed as a battery, though not particularly limited, may preferably be 20 μm or more and less than 1000 μm, it may be more preferable if it's 50 μm or more and less than 500 μm, and it is particularly preferable if it's 100 μm or more and less than 300 μm. The preferable thickness may vary depending on the thickness of the positive electrode layer 10, and the thickness of the insulating layer 13 may be appropriate if it is close to the thickness of the positive electrode layer 10.

As in the present embodiment, if the positive active material layer 12 is formed on both surfaces of the positive electrode current collector 11, the insulating layer 13 is also formed in two layers in the same way as the positive active material layer 12, as if the positive electrode current collector 11 and the positive electrode current collecting portion 111 are inserted from both sides. As such, the total thickness of the two-layer insulating layer 13, between which the positive electrode current collector 11 and the positive electrode current collecting portion 111 are inserted, is preferably of nearly the same thickness as the total thickness of the two positive active material layers 12 formed on both surfaces of the positive electrode current collector 11.

### 2. Feature Configuration of all-Solid-State Rechargeable Battery According to Present Embodiment

The position of the insulating layer 13 according to the present embodiment may be optically identifiable, on an outer side of the insulating layer 13, through the insulating layer 13, for at least a portion of an outer edge of the positive electrode current collector 11 which is covered by the insulating layer 13.

In this specification, being optically identifiable means, for example, that the position of the outer edge of the positive electrode current collector 11 disposed in the interior of the insulating layer 13 may be visually identifiable on the outer side of the insulating layer 13 by a human being since the insulating layer 13 is translucent or transparent, or that the image data on the outer side of the insulating layer 13 is obtained by an imaging device such as a camera, and the position of the outer edge of the positive electrode current collector 11 can be calculated based on the obtained image data.

In order to make the insulating layer 13 optically identifiable from the outer side, for example, it is preferable to form the insulating layer 13 with a resin having a total light transmittance of the insulating layer 13 by using a white color LED is 25% or more and less than 100% or others. The total light transmittance may preferably be 40% or more, and particularly preferably 60% or more.

Other indicators that can represent what is optically identifiable from the outer side of the insulating layer 13 include, for example, the linear light transmittance, reflective ratio, diffused light transmittance, haze value (diffused light transmittance×100/total light transmittance) of the insulating layer 13 or the resin forming the insulating layer 13. Meanwhile, in order to make the outer edge of the positive electrode current collector 11 optically identifiable by interposing the insulating layer 13 and the insulating layer 13, the value of at least one of these indicators may be within a preferable range.

For example, regarding the linear light transmittance, with respect to at least one wavelength within a wavelength range of 400 nm or more and 800 nm or less, the linear light transmittance in the case the thickness of insulating layer is 100 μm may be preferably 20% or more and less than 100%, and more preferably 21% or more, and particularly preferably 22% or more. In addition, with respect to two or three wavelengths within the wavelength range of 400 nm or more and 800 nm or less, the linear light transmittance may preferably be 20% or more.

As for the reflective ratio, it may preferably exceed 0% and be 80% or less, more preferably 40% or less, and particularly preferably less than 20%.

As for the diffused light transmittance, it may be preferable if it exceeds 0% and is 80% or less, it may be more preferable if it is 50% or less, and it is particularly preferable if it is less than 20%.

The haze value may preferably exceed 0% and be 90% or less, it may be even more preferable if it is 80% or less, and it is particularly preferable if it is less than 20%.

If the entire insulating layer 13 is made translucent or transparent, it is preferable because the outer edge of the positive electrode current collector 11 can be entirely seen by interposing the insulating layer 13, making it easier to confirm the position of the outer edge of the positive electrode current collector 11.

It is preferable if the positive electrode current collector is formed to a greater extent than the positive active material layer, such that at least a portion, more preferably all, of the outer edge of the positive electrode current collector is disposed to be located on the outer side of an outer edge of the positive active material layer.

### 3. Manufacturing Method of all-Solid-State Rechargeable Battery According to Present Embodiment

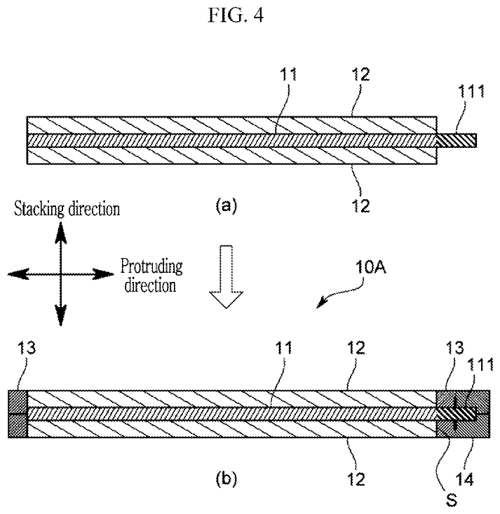

Hereinafter, an example of a method and sequence for manufacturing an all-solid-state rechargeable battery according to the present Embodiment 1 will be described with reference to FIGS. 4 to 9. Meanwhile, FIGS. 4, 7, 8 and 9 represent the cross-sectional view of the all-solid-state rechargeable battery during manufacture, cut along the A-A line in FIG. 3.

The manufacturing method of an all-solid-state rechargeable battery according to the present Embodiment 1 may include the following process.

### (3-1. Production of Positive Electrode Layer)

The material (such as the positive active material, binder, etc.) configuring the positive active material layer 12 is added to a non-polar solvent, thereby producing the positive active material layer coating liquid (this liquid could be in the form of a slurry or paste, which is also applicable to the coating liquid used to form another layer). Subsequently, as shown in FIG. 4(a), the obtained positive active material layer coating liquid is applied to both surfaces of the positive electrode current collector 11, and dried, and then, the positive electrode current collector 11 and the applied positive active material layer 12 are punched out into a rectangular plate shape by using tools like a Thompson blade. The laminate obtained in such a manner is referred to as a positive electrode layer structure. The positive electrode structure may be placed on an aluminum plate lined with a PET film, two sheets of the insulating layer material 13A may be disposed one by one to form the insulating layer 13 around the positive electrode structure, sandwiching the positive active material layer 12, and after placing another PET film entire on these, they may be laminated and subjected to pressurization treatment by isostatic pressing, thus applying pressure in the stacking direction to produce a positive electrode layer insulating layer composite 10A shown in FIG. 4(b).

Meanwhile, during the above-described pressurization process, it is preferable that the positive electrode current collecting portion 111 is entirely covered on both sides by a current collecting portion protecting member 14, which surrounds and protects a protruding portion of the positive electrode current collecting portion 111.

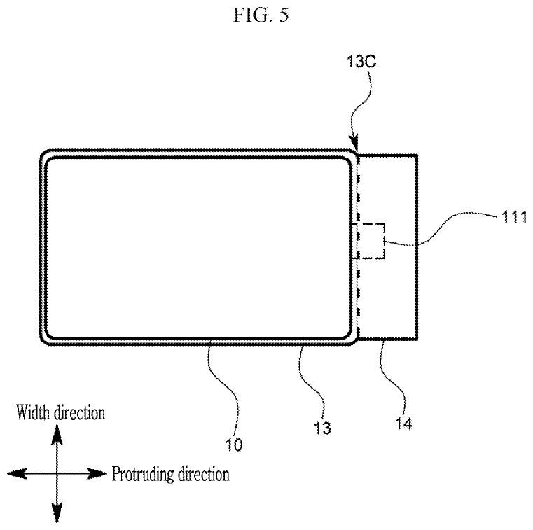

The current collecting portion protecting member 14 may have a greater surface than the area of the positive electrode current collecting portion 111, while its shape is not particularly limited, enabling it to entirety cover of the positive electrode current collecting portion 111 without a gap, while applying at least isotropic pressure. For example, as represented in FIG. 5, it is preferable in the manufacturing perspective that the current collecting portion protecting member 14 may be integrally formed with the insulating layer 13, and with the width and thickness as the width of the insulating layer 13, a surplus insulating layer 14 of a rectangular plate shape protruding more than the positive electrode current collecting portion 111 from the insulating layer 13 in the same direction as the positive electrode current collecting portion 111. Meanwhile, in each drawing, for easy understanding, an imaginary line is shown between the insulating layer 13 and the surplus insulating layer 14.

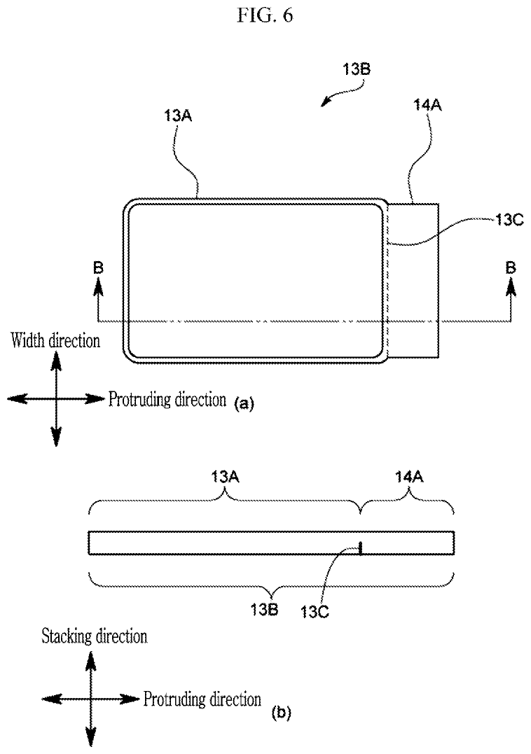

In the present embodiment, as shown in FIG. 6(a), the surplus insulating layer 14 may be formed by a current collecting portion protecting member material 14A, which is integrally formed on the end portion of the ring-shaped insulating layer material 13A.

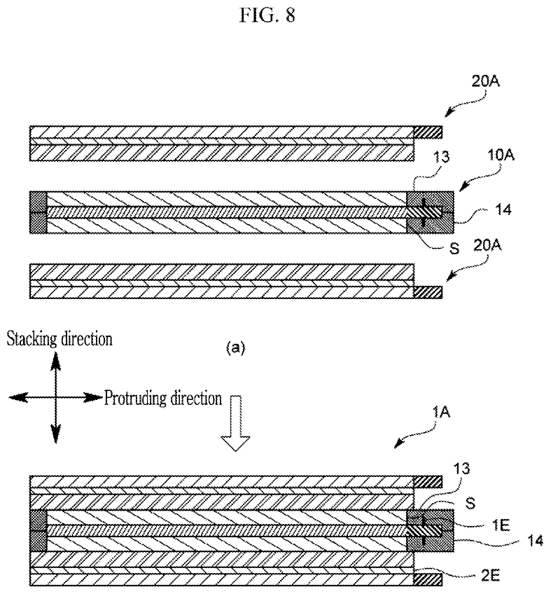

In the present embodiment, as shown in FIG. 8, two sheets of surplus insulating layer material 13B, which are provided with the insulating layer material 13A and the current collecting portion protecting member material 14A, may be prepared, after which these two sheets of the surplus insulating layer material 13B are disposed between the current collecting portion protecting member material 14A on both surfaces of the entire positive electrode current collecting portion 111, and then the isostatic pressing is performed, such that the positive electrode current collecting portion 111 is covered with the surplus insulating layer 14.

### (3-2. Production of Negative Electrode Layer)

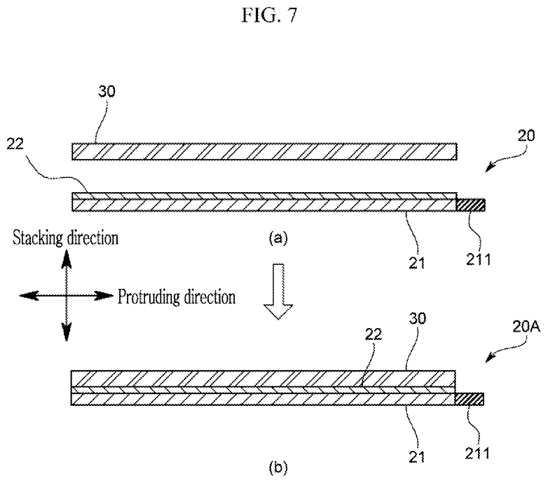

The negative active material layer coating liquid may be produced by adding material that configures the negative active material layer 22 (such as the negative active material, binder etc.) to a polarity solvent or non-polar solvent. Subsequently, as shown in FIG. 7(a), the obtained negative active material layer coating liquid may be applied to the negative electrode current collector 21 and may be dried. This may produce the negative electrode layer 20 by punching it out with a Thompson blade or similar to make it into a rectangular shape plate shape.

### (3-3. Production of Solid Electrolyte Layer)

The solid electrolyte layer 30 may be produced by a solid electrolyte formed from a sulfide-based solid electrolyte material. The production method of the solid electrolyte is as follows.

First, the starting raw material may be processed by the fusion quenching method or the mechanical milling method.

For example, when using the fusion quenching method, the starting raw material (e.g., Li₂S, P₂S₅ etc.) is mixed in a predetermined amount and formed into pellets, then reacted at a predetermined reaction temperature in a vacuum, and quenched, thereby producing a sulfide-based solid electrolyte material. Meanwhile, the reaction temperature of the mixture of Li₂S and P₂S₅ may preferably be 400° C. to 1000° C., and more preferably 800° C. to 900° C. In addition, the reaction time may preferably be 0.1 hour to 12 hours, and more preferably 1 hour to 12 hours. In addition, the quenching temperature of the reactant may typically be 10° C. or less, and preferably 0° C. or less, and the quenching speed may typically be from 1° C./sec to 10000° C./sec, and preferably from 1° C./sec to 1000° C./sec.

In addition, when using the mechanical milling method, the starting raw material (e.g., Li₂S, P₂S₅, or the like) may be agitated and reacted by using ball milling, thereby producing sulfide-based solid electrolyte material. Meanwhile, although the agitation speed and agitation time in the mechanical milling method are not particularly limited, a faster agitation speed may increase the generation speed of the sulfide-based solid electrolyte material, and a longer agitation time may increase the conversion rate of the raw material into the sulfide-based solid electrolyte material.

The granular-shaped solid electrolyte may be produced by heat treating the mixed raw material obtained by the fusion quenching method or the mechanical milling method at a predetermined temperature and thereafter crushing it. In cases where the solid electrolyte has a glass transition point, it can undergo a transition from amorphous to crystalline due to the heat treatment.

Continuing on, it is possible to produce a solid electrolyte layer coating liquid, which includes a dispersion medium, the solid electrolyte obtained through the above-described method, and other additives such as binders. As a dispersion medium, a universal non-polar solvent such as xylene or diethylbenzene may be used. Alternatively, it is also possible to use a solid electrolyte and a polarity solvent that has relatively insufficient reactivity. The concentration of the solid electrolyte and other additives may be appropriately adjusted depending on the composition of the solid electrolyte layer 30 being formed and the viscosity of the liquid composition.

The liquid composition of the above-described solid electrolyte may be coated onto the surface of PET film, which has been release-treated, with a blade, and after drying, the solid electrolyte sheet in which the solid electrolyte layer 30 is formed on the PET film may be produced.

### (3-4. Stack Process)

As shown in FIG. 7(a), a solid electrolyte sheet, which has been perforated to have a shape the same as or larger than the negative electrode layer 20, may be stacked on the first side surface of the negative electrode layer 20 produced as described above, and as shown in FIG. 7(b), these may be integrated by tightly contacting the negative electrode layer 20 and the solid electrolyte layer 30 through isostatic pressing. If the shape of the solid electrolyte layer 30 is greater than the negative electrode layer 20, it is also possible to remove the part in the solid electrolyte layer 30 that protrudes on the outer side when stacked on the negative electrode layer 20. This laminate will be referred to as an electrolyte negative electrode structure 20A.

Subsequently, as shown in FIG. 8(a), the above-mentioned positive electrode layer insulating layer composite 10A may be stacked to be inserted between two electrolyte negative electrode structures 20A on both sides. At this time, the electrolyte negative electrode structure 20A may be stacked such that the solid electrolyte layer 30 of the electrolyte negative electrode structure 20A may be in contact of each of the both surfaces of the positive electrode layer 10, and by laminate packing and isostatic pressing them entirely, a trimmed all-solid-state rechargeable battery 1A as represented in FIG. 8(b) may be manufactured.

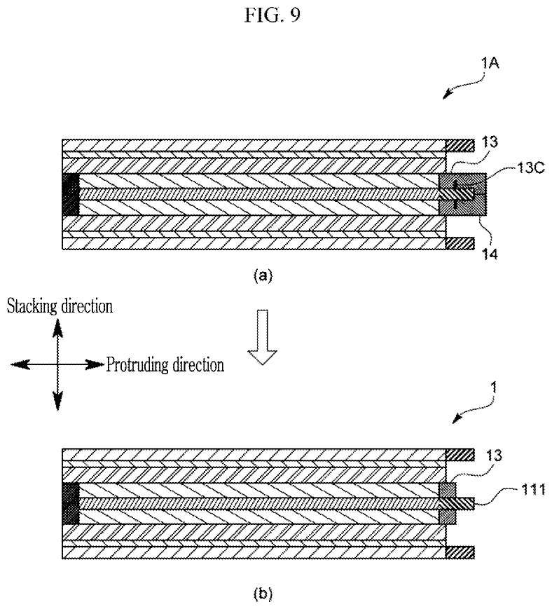

Meanwhile, in FIG. 1, FIG. 2, FIG. 8, and FIG. 9, although it may appear that there is a gap between the negative electrode current collecting portion 211 and the insulating layer 13, at the time point where they are stacked, there is actually almost no gap, and the entire negative electrode current collecting portion 211 is supported by the insulating layer 13 from its first side surface by being pressurized by the insulating layer 13.

In the present embodiment, in the above-described stack process, as shown in FIG. 3, one side of an outer edge 1E of the insulating layer 13 extends to the outer side, beyond both the positive electrode current collecting portion 111 and the negative electrode current collecting portion 211, in a protruding direction of the positive electrode current collecting portion 111 and the negative electrode current collecting portion 211. In the present embodiment, although it has been explained that one entire side of the insulating layer 13 aligns with the same position in the protruding direction of the outer edge 1E, the outer edge 1E of the insulating layer 13 may be in the shape that extends in the portion where the positive electrode current collecting portion 111 and the negative electrode current collecting portion 211 are protruding, in the protruding direction.

Even if the outer edge 1E of the insulating layer 13 protrudes only in the portion where the positive electrode current collecting portion 111 and the negative electrode current collecting portion 211 protrude as described above, it is preferable that the entire outer edge 1E in the protruding direction is disposed on the outer side of the outer edge of an outer edge 2E of the negative electrode layer 20. In addition, when the outer edge 2E of the negative electrode layer 2 is located on the insulating layer 13, even if the negative electrode layer 20 is deformed by being pressurized toward the positive electrode layer 10 by the external pressure, short-circuiting caused by physical contact between the positive electrode layer 10 and the negative electrode layer 20 may be suppressed, which is thereby preferable.

The term “the outer edge 1E” of the insulating layer 13 refers to the edge (outer edge) on the outermost side in a direction perpendicular to the stacking direction, among the side cross-sections of the insulating layer 13, as shown in FIG. 3. In addition, the term “outer edge 2E” of the negative electrode layer 20 refers to the edge (outer edge) of the outermost side among side cross-sections of the negative electrode layer 20 in the direction perpendicular to the stacking direction, and in the present embodiment, for example, refers to the edge of the outermost side among side cross-sections of the negative electrode current collector 21 or the negative active material layer 22 in the direction perpendicular to the stacking direction.

It is preferable that the thickness of the insulating layer 13 in an extension portion 13F extending to support the positive electrode current collecting portion 111 and the negative electrode current collecting portion 211 is the same as the thickness of the insulating layer 13 in the above-described ring-shaped portion 13E.

By configuring as described above, during the isostatic pressing described later, the positive electrode current collecting portion 111 and the negative electrode current collecting portion 211 may be protected and supported without any steps as much as possible on the entire surface by the insulating layer 13 from at least the first side surface.

### (3-5. Isostatic Pressing)

Hereinafter, the pressurization process using the isostatic pressing described above will be described.

The isostatic pressing may be performed by disposing a support plate, such as a SUS plate, for example, on the surface of at least the first side of the laminate. Each laminate that forms the isostatic pressing of the positive electrode layer insulating layer composite 10A, the electrolyte negative electrode structure 20A or the all-solid-state rechargeable battery 1, may undergo pressurization treatment from its stacking direction.

As a pressure medium for isostatic pressing, liquids such as water or oil, or powders may be used. As a pressure medium, it is more preferable to use liquid.

The pressure in isostatic pressing may, although not particularly limited, for example, be 10 to 1000 MPa, preferably 100 to 500 MPa. In addition, the pressurization time is not particularly limited, but it may, for example, be from 1 to 120 minutes, preferably from 5 to 30 minutes. In addition, the temperature of the pressure medium during pressurization is not particularly limited, and for example, it may be between 20° C. to 200° C., preferably 50° C. to 100° C.

Meanwhile, during the isostatic pressing, it is preferable that the laminate configuring the all-solid-state rechargeable battery 1, together with the support plate, is laminated by means such as a resin film, and is in a state blocked from the external atmosphere.

Compared to other press methods such as a roll press, isostatic pressing is advantageous from the standpoint that it allows for high-pressure pressing unrelated to the suppression of cracks in the respective layers configuring the all-solid-state rechargeable battery 1, the prevention of bending of the all-solid-state rechargeable battery 1, or the increase in electrode area.

Thereafter, as shown in FIG. 9, the trimmed all-solid-state rechargeable battery 1A may be completed through a removal process where the surplus insulating layer 14 is removed from the all-solid-state rechargeable battery 1A. Meanwhile, in FIG. 9, FIG. 9(a) represents the trimmed all-solid-state rechargeable battery 1A, and FIG. 9(b) represents the all-solid-state rechargeable battery 1 after removing the surplus insulating layer 14. In FIG. 9, the insulating layer 13 is formed by two sheets of the insulating layer material 13A, but these insulating layer materials 13A, for example, can be heated and integrate during the first charge.

The surplus insulating layer 14 may be manually trimmed, for example, by manually pulling in the direction perpendicular to the stacking direction of the respective layers configuring the all-solid-state rechargeable battery 1, so that the positive electrode current collecting portion 111 can be exposed. At this time, for example, when a cut 13C is made in the thickness direction between the insulating layer 13 and the surplus insulating layer 14 as shown in FIG. 6(b), it is easy to remove the surplus insulating layer 14.

Meanwhile, the method of removing the surplus insulating layer 14 is not limited to the above-described one, and for example, it may be removed not by a human hand but by tools or machines.

### 4. Effect of all-Solid-State Rechargeable Battery According to Present Embodiment

According to the present Embodiment 1 of an all-solid-state rechargeable battery, after covering the side cross-section of the positive electrode layer with the insulating layer, it may be observed early if the position of the positive electrode current collector is misaligned or if the positive electrode current collector is bent, hence the positive electrode current collector is not disposed in the desired position.

As a result, by suppressing the generation of a short circuit caused by the positive electrode current collector not being disposed in the desired position, it may provide an all-solid-state rechargeable battery that is more resistant to short circuiting than conventional ones.

### 5. Manufacturing Method of Stacked all-Solid-State Rechargeable Battery According to Present Embodiment

By stacking a plurality of all-solid-state rechargeable batteries 1 manufactured as described above, it may be possible to manufacture a stacked all-solid-state rechargeable battery.

When stacking the all-solid-state rechargeable batteries 1, the positive electrode current collecting portions 111 and the negative electrode current collecting portions 211 of a plurality of all-solid-state rechargeable batteries 1 are aligned in the stacking direction to overlap with each other, respectively, and then pressurized or welded, such that the positive electrode current collecting portions 111, which are provided by each all-solid-state rechargeable battery 1, may become conductive with each other and the negative electrode current collecting portions 211 may become conductive with each other.

### 6. Charging and Discharging of all-Solid-State Rechargeable Battery According to Present Embodiment

Charging and discharging of an all-solid-state rechargeable battery according to the present Embodiment 1 will be hereinafter described.

In the all-solid-state rechargeable battery 1 according to the present embodiment, in the early stage of charging, the negative active material capable of forming an alloy or compound with lithium within the negative active material layer 22 forms an alloy or compound with lithium ion, and accordingly, lithium may intercalate within the negative active material layer 22. Thereafter, once the charge capacity exerted by the negative active material layer 22 is exceeded, metal lithium may be precipitated on one side or both side surfaces of the negative active material layer 22, forming a metal lithium layer. Since the metal lithium is formed through diffusion interposing the negative active material capable of forming an alloy or compound, it may be uniformly formed principally between the negative active material layer 22 and the negative electrode current collector 21, rather than in the resin shape (dendrite form). During discharging, the metal lithium in the negative active material layer 22 and the metal lithium layer is ionized and moves toward the positive active material layer 12. Therefore, as metal lithium itself can be used as the negative active material, the energy density may be improved.

In addition, when the metal lithium layer is formed between the negative active material layer 22 and the negative electrode current collector 21, i.e., within the negative electrode layer 20, the negative active material layer 22 covers the metal lithium layer. Accordingly, the negative active material layer 22 may function as a protective layer for the metal lithium layer. Accordingly, the short circuit and capacity degradation of the all-solid-state rechargeable battery may be suppressed, and furthermore, the characteristics of the all-solid-state rechargeable battery may be improved.

In the negative active material layer 22, a method that allows the precipitation of metal lithium can be, for example, a method that makes the charge capacity of the positive active material layer 12 greater than the charge capacity of the negative active material layer 22. Specifically, the capacity ratio of the charge capacity of the positive active material layer 12 to the charge capacity of the negative active material layer 22 may satisfy the requirement of the following Equation 1:

$$0.002 < b / a < 0.5 \qquad [ Equation 1 ]$$

In Equation 1, ‘a’ represents the charge capacity (mAh) of the positive active material layer 12, and ‘b’ represents the charge capacity (mAh) of the negative active material layer 22.

When the capacity ratio indicated as the Equation 1 is greater than 0.002, regardless of the configuration of the negative active material layer 22, the negative active material layer 22 can sufficiently mediate the precipitation of metal lithium from the lithium ion, and accordingly, it easier to appropriately perform the formation of the metal lithium layer. In addition, it is preferable if the metal lithium layer is formed between the negative active material layer 22 and the negative electrode current collector 21, as the negative active material layer 22 can sufficiently function as a protective layer. Accordingly, the capacity ratio may be, more preferably, 0.01 or more, and even more preferably 0.03 or more.

In addition, since there is no case where the capacity ratio is less than 0.5 and not case the negative active material layer 22 stores the majority of lithium during charging, it becomes easy to uniformly form a metal lithium layer, regardless of the configuration of the negative active material layer 22. The capacity ratio may be, more preferably, 0.2 or less, and further preferably, 0.1 or less.

The capacity ratio being greater than 0.01 is more preferable. It is because, if the capacity ratio becomes 0.01 or less, there is a possibility that the characteristics of the all-solid-state rechargeable battery 1 may deteriorate. As a reason, it can be cited that the negative active material layer 22 does not sufficiently function as a protective layer. For example, when the thickness of the negative active material layer 22 is very thin, the capacity ratio may be 0.01 or less. In this case, the negative active material layer 22 may collapse due to the repetition of charge and discharge, and there is a possibility that dendrite can precipitate and grow. As a result, there is a concern that the characteristics of the all-solid-state rechargeable battery 1 may deteriorate. In addition, it is preferable if the capacity ratio is even smaller than 0.5. It is because if the capacity ratio exceeds 0.5, the amount of lithium precipitation in the negative electrode layer 20 may decrease, which could potentially reduce the battery capacity. For the same reason, it is more preferable if the capacity ratio is less than 0.25. In addition, the output characteristics of the battery may further improve as the capacity ratio is less than 0.25.

Here, the charge capacity of the positive active material layer 12 is obtained by multiplying the charge specific capacity (mAh/g) of the positive active material by the mass of the positive active material in the positive active material layer 12. In cases where multiple types of the positive active material are used, the value of charge specific capacity X mass is calculated for each every positive active material, and the grand total of these values may be set as the charge capacity of the positive active material layer 12. The charge capacity of the negative active material layer 22 may also be calculated using the same method. That is, the charge capacity of the negative active material layer 22 is obtained by multiplying the charge specific capacity (mAh/g) of the negative active material by the mass of the negative active material in the negative active material layer 22. In cases where multiple types of the negative active material are used, the value of charge specific capacity X mass is calculated for each negative active material, and the grand total of these values may be set as the charge capacity of the negative active material layer 12. Here, the charge specific capacity of the positive active material and the negative active material may be an approximated capacity when utilizing a lithium metal as a counter electrode in an all-solid-state half cell. In reality, the charge capacity of the positive active material layer 12 and the negative active material layer 22 may be directly measured by using an all-solid-state half cell for the measurement.

There is a method to directly measure the charge capacity, as described below. Firstly, the charge capacity of the positive active material layer 12 may be measured by producing an all-solid-state half cell using the positive active material layer 12 as the working electrode and Li as the counter electrode, and performing CC-CV charging from the OCV (open voltage) to the upper limit charge voltage. The term “upper limit charge voltage” is defined by the provisions of JIS C 8712:2015, and refers to 4.25 V with respect to the positive active material layer 12 that uses the positive active material of lithium cobalt acid-based, and the required voltage by applying the provisions of A.3.2.3 (safety requirements when applying different upper limit charging voltages) of JIS C 8712:2015 with respect to the positive active material layer 12 that uses other positive active materials. The charge capacity of the negative active material layer 22 can be measured by producing an all-solid-state half cell using the negative active material layer 22 as the working electrode and Li as the counter electrode, and performing a CC-CV charge from the OCV (open voltage) to 0.01V.

The charge specific capacity may be calculated by dividing the charge capacity measured as such by the mass of each active material. The charge capacity of the positive active material layer 12 may be the initial charge capacity measured during the first cycle of charge.

In an embodiment, it is ensuring that the charge capacity of the positive active material layer 12 is in excess of the charge capacity of the negative active material layer 22. As will be described later, in the present embodiment, the all-solid-state rechargeable battery 1 may be charged exceeding the charge capacity of the negative active material layer 22. That is, the negative active material layer 22 may be overcharged. At the early stage of charging, lithium may be intercalated into the negative active material layer 22. That is, the negative active material may form an alloy or compound with the lithium ion that has moved from the positive electrode layer 10. If charging exceeds the capacity of the negative active material layer 22, lithium may precipitate on the side of the negative active material layer 22, i.e., between the negative electrode current collector 21 and the negative active material layer 22, and a metal lithium layer may be formed by this lithium.

This phenomenon may be generated by configuring the negative active material as a material that specifies, that is, a material forming an alloy or compound with lithium. During discharge, lithium in the negative active material layer 22 and metal lithium layer may ionize and move towards the positive electrode layer 10. Therefore, in the all-solid-state rechargeable battery 1, metal lithium may be used as the negative active material. More specifically, when the charge capacity of the negative electrode layer 20 (the sum of the charge capacities exerted by the negative active material layer 22 and the aforementioned metal lithium layer) is considered as 100%, it is preferable that 80% or more of the charge capacity is exerted by the metal lithium layer.

In addition, the negative active material layer 22 covers the previously mentioned metal lithium layer from the side of the solid electrolyte layer 30, and may serve as a protective layer for the metal lithium layer, potentially suppressing the precipitation and growth of dendrites. Accordingly, the short circuit and capacity degradation of the all-solid-state rechargeable battery 1 may be suppressed more efficiently, and furthermore, the characteristics of the all-solid-state rechargeable battery 1 may be improved.

### 7. Another Embodiment According to Present Invention

An all-solid-state rechargeable battery according to the present invention is not limited to the above-described one.

The current collecting portion protecting member may be provided with a conductive portion configured to electrically connect the positive electrode current collecting portion or negative electrode current collecting portion to the external wire, such that the current collecting portion protecting member may not be trimmed to remain as a portion of the insulating layer.

It is not limited to making the entire insulating layer 13 translucent or transparent, and it may also be possible to make only a portion of the insulating layer translucent or transparent.

In instances where visibility of only a portion of the positive electrode current collector is enabled as only a portion of the insulating layer is formed with a transparent resin, it is preferable if an outer edge of the positive electrode current collecting portion, which can be particularly great in impact when its position is misaligned, is made visible.

The positive electrode current collector may not be limited to being more greatly formed than the positive active material layer, and it may also be that only the positive electrode current collecting portion protrudes toward the outer side from the positive active material layer.

In the embodiment, it was explained that an insulating layer is disposed in the side cross-section of the positive electrode layer, but it may also include an insulating layer in the side cross-section of the negative electrode layer.

The solid electrolyte layer 30 installed between the positive electrode layer and the negative electrode layer may be stacked at least 1 layer, and it may also be stacked 2 layers, 3 layers, 4 layers or more.

The present invention may not be limited to an all-solid-state lithium ion rechargeable battery, but may be provided with a thin current collecting portion, and may also be applied to a wide range of all-solid-state rechargeable batteries that are manufactured by forming with pressurization processing such as isostatic pressing.

### EMBODIMENT

Hereinafter, specific examples will be given to explain the present invention in more detail, but it should be understood that the present invention is not limited to these examples.

### <Review on Insulative Resin Material for Forming Insulating Layer>

In the following embodiments and Comparative Example, when the insulating layer is formed by using the insulative resin film used to form the insulating layer, whether the position of the outer edge of the internally disposed positive electrode current collecting portion is optically identifiable from the outer side of the insulating layer (hereinafter, referred to as visibility) was confirmed as follows.

### [Linear Light Transmittance]

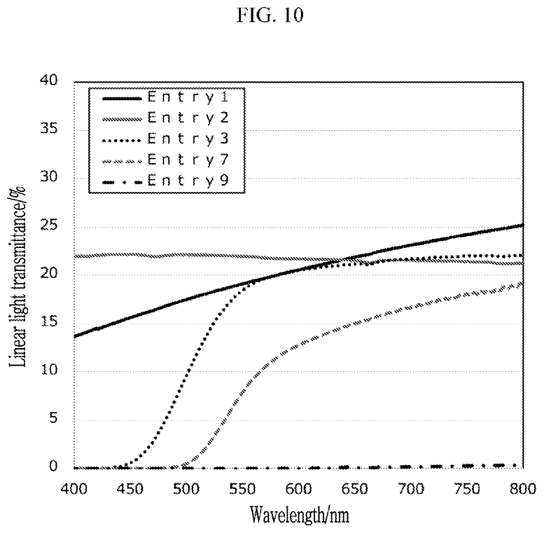

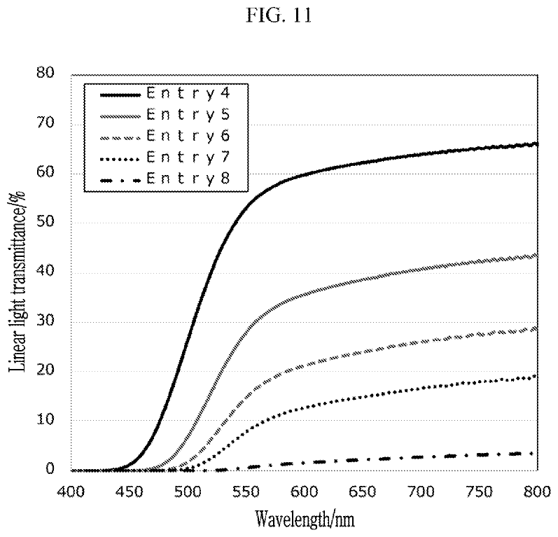

A positive electrode current collecting film cut into 2.5 cm×2.5 cm is sandwiched between resin films cut into 3.1 cm×3.1 cm, and pressurization treatment was performed using a WIP device at 490 MPa for 30 minutes. In Table 1, the case where the positive electrode current collecting film could be clearly seen beyond the insulating layer sheet is represented as ⊚, the case partially difficult to identify but confirmable as ◯, and the case unidentifiable as X. Meanwhile, due to the varying thickness of the resin film, measurement value is adjusted based on the film thickness and the linear light transmittance calculated based on 100 μm is represented in FIG. 10 and FIG. 11, and values of the linear light transmittance measured by the ultraviolet, visible, and near-infrared spectrophotometer UV3600 (manufactured by Shimadzu Corporation) with respect to 450 nm, 600 nm, and 750 nm as a representative wavelength are summarized in Table 1. From the results, it may be seen that, in the insulating layer to make the outer edge of the positive electrode current collector visually identifiable from the outside, with respect to at least one wavelength of 400 nm or more and 800 nm or less, the linear light transmittance in the case the thickness of insulating layer is 100 μm is 20% or more and 100% or less.

TABLE 1

| | Linear light transmittance | | | |
|---|---|---|---|---|
| | at each wavelength (%) | | | Visibility |
| | 450 nm | 600 nm | 750 nm | evaluation |
| Entry 1 | 15.6 | 20.6 | 24.2 | ⊚ |
| Entry 2 | 22.2 | 21.7 | 21.4 | ⊚ |
| Entry 3 | 0.5 | 20.5 | 21.9 | ◯ |
| Entry 4 | 1.2 | 59.8 | 65.5 | ⊚ |
| Entry 5 | 0 | 35.6 | 42.5 | ◯ |
| Entry 6 | 0 | 21.3 | 27.7 | ◯ |
| Entry 7 | 0 | 12.7 | 18.1 | X |
| Entry 8 | 0 | 1.6 | 3.3 | X |
| Entry 9 | 0 | 0 | 0.3 | X |

### [Total Light Transmittance]

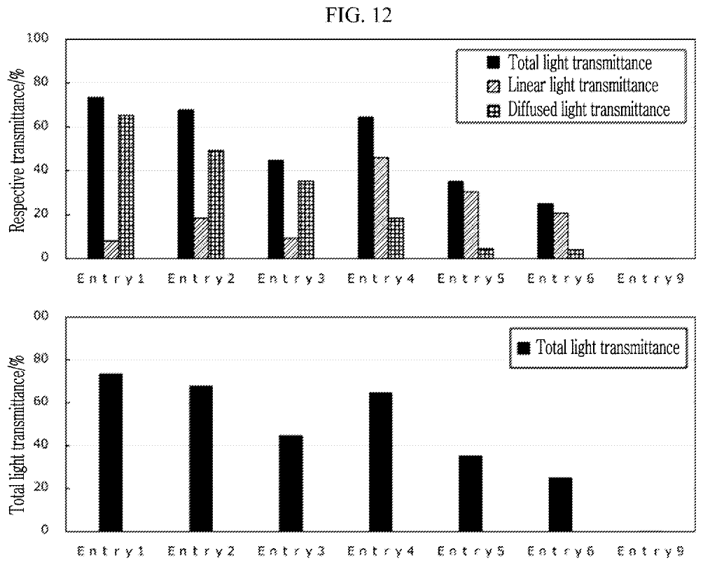

Although the visibility may be evaluated based on the linear light transmittance of the film, a better indicator may be needed depending on actual film thickness, due to diffusion of the film or the like. Therefore, the total light transmittance was measured using a Haze meter NDH7000 manufactured by Nippon Denshoku Industries. Here, it represents that total light transmittance=straight line transmittance+diffusion transmittance. The measuring method was conducted in accordance with JIS K7136, and a white color LED was used as the light source. The resin film which had undergone pressurization treatment using the WIP device for 30 minutes at 490 MPa was utilized. The results of the measurements on the resin films of Entry 1, 2, 3, 4, 5, 6, and 9 are represented in FIG. 12 and Table 2. From these results, it appears that the resin film with visible visibility has a total light transmittance of more than 25%.

TABLE 2

| | Total light transmittance (%) | Visibility evaluation |
|---|---|---|
| Entry 1 | 73.4 | ⊚ |
| Entry 2 | 67.8 | ⊚ |
| Entry 3 | 44.7 | ◯ |
| Entry 4 | 64.5 | ⊚ |
| Entry 5 | 35.2 | ◯ |
| Entry 6 | 25.0 | ◯ |
| Entry 7 | 0 | X |

### [Laser Light Reflection Experiment]

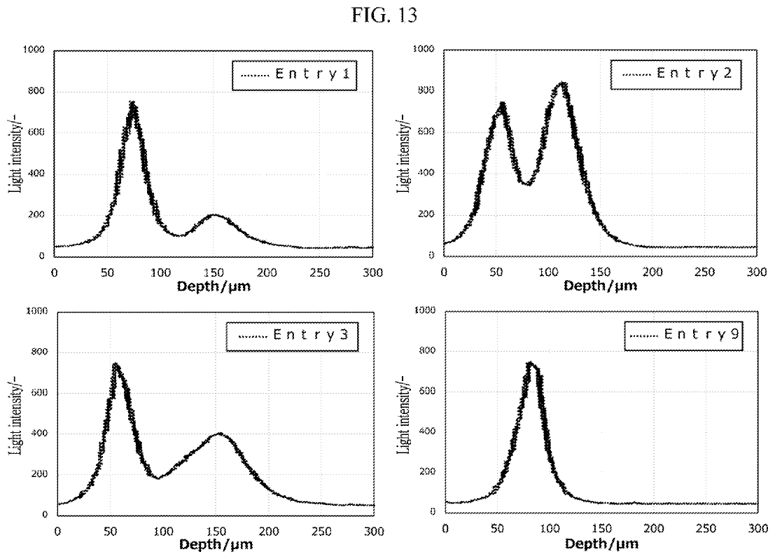

By using the same in which the positive electrode current collector used for measuring the above-described linear light transmittance is inserted between resin films, the reflected light was detected by illuminating the laser light of wavelength 655 nm on the current collecting film over the resin film. The laser displacement meter LK-G10A (manufactured by Keyence) was used as a measuring device. Entry 1, 2, 3, 9 were used as a resin film. As shown in FIG. 13, in the case of the sample of which the outer edge of the positive electrode current collector is visually identifiable from the outside of the insulating layer, two peaks of the reflection light exist, and in the case of visually unidentifiable sample, only one peak of the reflection light was observed. This may be because, while only the reflection light from the resin film surface is detected when visually unidentifiable, the reflection light from both of the resin film surface and current collecting film surface are detected when visually identifiable. In this measurement, it was shown that the optical function provided by the machine could be detected.

### Embodiment 1

In Embodiment 1, an all-solid-state rechargeable battery forming the insulating layer by using the insulative resin film of Entry 1 of Table 1 was produced.

### [Production of Positive Electrode Layer Structure]

LiNi_{0.8}Co_{0.15}Mg_{0.05}O₂ (NCM) was utilized as the positive active material. This active material was coated with Li₂O—ZrO₂ using the method described in Non-Patent Document 2. The Li₆PS₅Cl, an Argyrodite-type determination, was prepared as a solid electrolyte. In addition, as a binder, a polytetrafluoroethylene (TEFLON (registered trademark) manufactured by Dupont Company) binder was prepared. In addition, carbon nano fiber (CNF) was prepared as a conductive aid. Subsequently, these materials were mixed in a mass ratio of the positive active material:solid electrolyte:conductive aid:binder=85:15:3:1.5 to form a mixture, which was then stretched into a sheet shape to produce a positive electrode sheet. Additionally, this bipolar sheet was used by punching it into a predefined shape with a Thompson blade. As the positive electrode current collector, an aluminum foil of 10 μm thickness coated with an undercoat layer of 1 μm thickness and then punched into a specified shape with a Pinnacle die was used. At this time, one having larger exterior circumference was used as the positive electrode current collector, such that an entire circumference of the outer edge of the positive electrode current collector may be located outside of the positive active material layer.

The positive electrode current collector and the positive active material layer is placed on an aluminum plate (support member) of 3 mm thickness attached with a PET film (hereinafter, releasing film) whose surface has been release-treated, two sheets of the surplus insulating layer material 13B are disposed such that the ring-shaped portion may surround the positive active material layer 12 and the positive electrode current collecting portion 111 in which the current collecting portion protecting member material 14A protrudes from the positive electrode current collector 11 may be inserted between the both sides, this was covered by a releasing film and also covered with a metal plate (support member) of a SUS material in the same shape as the shape in which ring-shaped portions of the positive active material layer and the surplus insulating layer material 13B, that is, the shape that does not cover the current collecting portion protecting member material 14A among the surplus insulating layer material 13B, by a 0.3 mm thickness, and vacuum laminate packing was performing by including the support member. By submerging in a pressurizing medium and performing hydrostatic pressure treatment (consolidation process using an isostatic pressing) at 490 MPa, the portion of the insulating layer material 13A of the surplus insulating layer material 13B was integrated with the positive electrode current collector 11 and the positive active material layer 12. At this time, the positive electrode conductive portion 13E1 may be in a structure in contact with the positive electrode current collecting portion 111 formed to protrude from the positive electrode current collector 11.

A structure provided with the positive electrode layer 10 in which the positive active material layer 12 is stacked on the both surfaces of the positive electrode current collector 11, and the insulating layer 13 and the current collecting portion protecting member 14 covering surfaces around the side surface different from the stacking direction of the positive active material layer 12 will be referred to as the positive electrode layer insulating layer composite 10A.

The above-described surplus insulating layer material 13B was produced as follows. The surplus insulating layer material 13B, in which an accommodation hole for accommodating the positive active material layer 12 is formed, was manufactured by piercing through the resin film with insulating property, for example, with Pinnacle die (registered trademark). The resin film with insulating property used in the present embodiment may be the one produced by Daicel Corporation, which contains resin non-woven fabric as an insulative filler. As shown in FIG. 6, the shape of the surplus insulating layer material 13B is formed in a structure in which the current collecting portion protecting member material 14A of a rectangular shape for protecting the current collecting portions 111 and 211 extends in a first direction from the ring-shaped insulating layer material 13A having an accommodation hole of a size that can exactly surround the positive active material layer 12.

### [Production of Negative Electrode Layer]

As the negative electrode current collector 21, a nickel foil current collector of a 10 μm thickness was prepared. In addition, as the negative active material, CB1 manufactured by Asahi Carbon Co., (with a nitrogen adsorption specific surface area of about 339 m²/g, and a DBP oil supply amount of about 193 ml/100 g), CB2 also manufactured by Asahi Carbon Co., (with a nitrogen adsorption specific surface area of about 52 m²/g, and a DBP oil supply amount of about 193 ml/100 g), and silver particles with a 60 nm particle diameter were prepared. Meanwhile, the particle diameter of these silver particles may be measured by using, for example, a laser diffraction distribution system to determine the median diameter (the so-called D50).

Subsequently, 1.5 g of CB1 and 1.5 g of CB2, and 1 g of silver particles were put into a container, and then 4 g of N-Methylpyrrolidone (NMP) solution, which includes 5 mass % of the binder (manufactured by Kureha #9300), was added. Subsequently, by gradually adding a total of 30 g of NMP to this mixed solution and agitating the mixed solution, the negative active material layer coating liquid was produced. The negative active material layer coating liquid may be applied onto the Ni foil using a blade coater, and then dried in air at 80° C. for about 20 minutes to form the negative active material layer 22. The laminate obtained thereby was vacuum-dried at 100° C. for about 12 hours and punched out with a Pinnacle die (registered trademark). The negative electrode layer 20 was produced by the above process.

### [Production of Solid Electrolyte Sheet]

First, a solid electrolyte layer coating liquid was produced.

A primary mixture slurry was generated by adding an SBR binder, which was dissolved in dehydration xylene, to the Li₂S—P₂S₅ (80:20 mol %) amorphous powder as a sulfide-based solid electrolyte, until it becomes 1 mass % of the solid electrolyte. In addition, a secondary mixture slurry was generated by adding an appropriate amount of dehydration xylene and dehydration diethylbenzene for viscosity adjustment to this primary mixture slurry. In addition, in order to improve dispersion of the mixture powder, a zirconia ball of diameter 5 mm were introduced into a third mixture slurry such that the space, mixture powder, and zirconia ball may occupy ⅓ of the entire volume of the kneading vessel, respectively. The third mixture liquid produced through this process was introduced into the rotary mixer, and the solid electrolyte layer coating liquid was produced by agitating for 3 minutes at 3000 rpm.

The produced solid electrolyte layer coating liquid may be coated on the PET film whose surface has been release-treated, with a blade, and then dried on a hot plate at 40° C. for 10 minutes, followed by vacuum-drying at 40° C. for 12 hours to obtain a solid electrolyte sheet. The thickness of the solid electrolyte layer after drying was approximately 65 μm. The dried solid electrolyte sheet was perforated using a Thompson blade and processed to a predetermined size.

### [Production of Electrolyte Negative Electrode Structure]

A solid electrolyte sheet may be disposed on the surface of the negative electrode layer 20 such that the solid electrolyte layer 30 and the negative active material layer 22 may be in contact, these are placed on an aluminum plate (support member) of a 3 mm thickness attached with the releasing film, and vacuum laminate packing was performed by including the support member. By submerging in a pressurizing medium and performing hydrostatic pressure treatment (consolidation process using an isostatic pressing) at 50 MPa, the solid electrolyte layer on solid electrolyte sheet was integrated with the negative electrode layer 20. This will be referred to as the electrolyte negative electrode structure 20A.

[Production of all-Solid-State Rechargeable Battery]

By disposing the positive electrode layer insulating layer composite 10A between the two electrolyte negative electrode structures 20A, a laminate, which is an all-solid-state rechargeable battery before pressurization, was obtained. This laminate was placed on an aluminum plate (support member) of a 3 mm thickness attached with a releasing film, covered with the releasing film, also covered with a metal plate (support member) of a SUS material of a 0.3 mm thickness in the same shape as one used in the [Production of positive electrode layer], and then vacuum laminate packing was performed by including the support member. By submerging in a pressurizing medium and performing hydrostatic pressure treatment (consolidation process using an isostatic pressing) at 490 MPa, the trimmed all-solid-state rechargeable battery 1A was obtained. Lastly, the surplus insulating layer 14 was cut off from the all-solid-state rechargeable battery 1A, and thereby a single cell of the all-solid-state rechargeable battery 1 was obtained.

Meanwhile, in the present embodiment, an aluminum plate and a metal plate of SUS are used as support materials, but these support materials can be any material that has the strength to withstand pressurization by isotropic pressure.

[Evaluation of Charge and Discharge of all-Solid-State Rechargeable Battery]

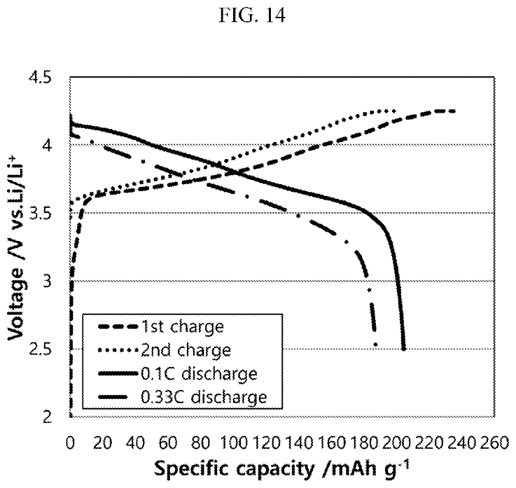

The single cell of the produced all-solid-state rechargeable battery 1 may be inserted between two sheets of metal plate from the outer side of its stacking direction, a screw with a previously installed plate spring passes through the hole in the metal plate, and the screw was fastened to ensure the applied pressure on the battery is 1.0 MPa. The characteristics of the battery was evaluated by the charge and discharge evaluation apparatus TOSCAT-3100, under the charge and discharge condition that a metal tab for connecting an outer terminal is welded to the positive electrode current collecting portion 111 and the negative electrode current collecting portion 211, subsequently, charged until the upper limit voltage 4.25 V with a constant current of 0.1 C at 45° C., charged with a constant voltage until the current becomes 0.05 C, and discharged until the final voltage 2.5 V at 0.1 C. Meanwhile, evaluation of charge and discharge results performed under the same charge and discharge condition is represented in FIG. 14. As shown in FIG. 14, the all-solid-state rechargeable battery produced in Embodiment 1 exhibited good charge and discharge characteristics.

[Cycle Evaluation of all-Solid-State Rechargeable Battery]

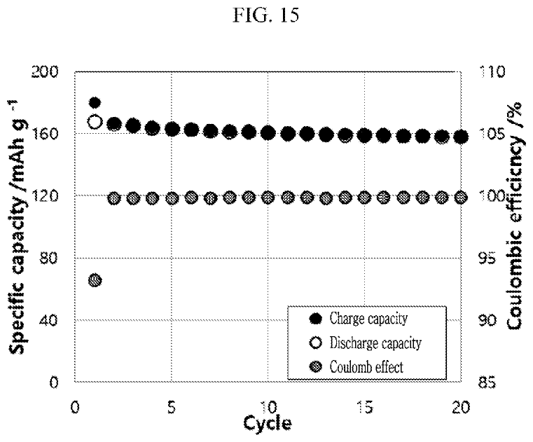

In addition, for cycle evaluation of charge and discharge, the charge and discharge cycle evaluation was performed as described in the description with respect to the evaluation of charge and discharge, in which, with respect to the all-solid-state rechargeable battery in the pressurized state, charged until the upper limit voltage 4.25 V with a constant current 0.33C at 45° C., then charged with a constant voltage until the current becomes 0.1 C, and discharged at 0.33C until the final voltage 2.5 V. The result is represented in FIG. 15.

From the results, it was confirmed that the all-solid-state rechargeable battery produced in Embodiment 1 is cycling through stable charge and discharge without being short-circuited.

### Embodiment 2

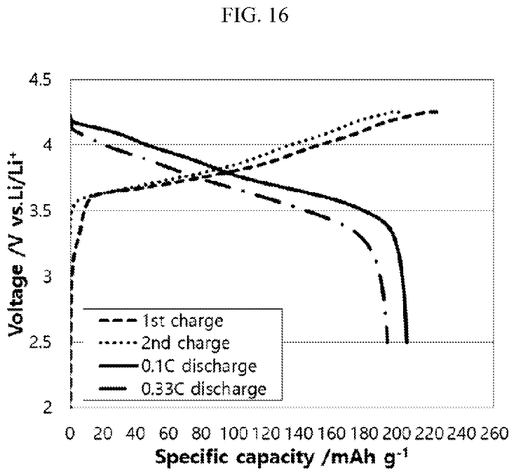

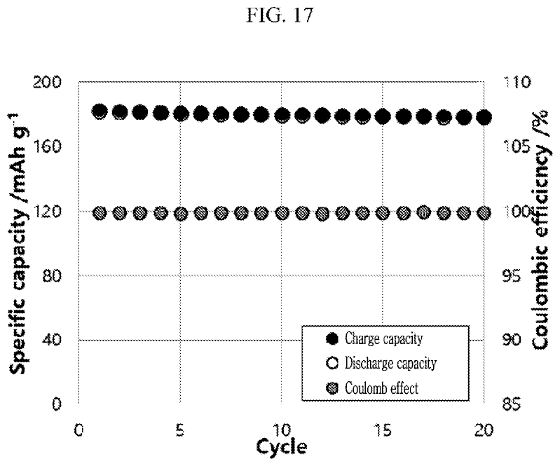

An all-solid-state rechargeable battery was produced in the same way as in Embodiment 1 except that the insulative resin film of Entry 3 of Table 1 was used, and the charge and discharge test and the cycle test were performed under the same condition as in Embodiment 1. The result is represented in FIG. 16 and FIG. 17.

From the results of FIG. 16 and FIG. 17, it was confirmed that the all-solid-state rechargeable battery produced in Embodiment 2 represents good charge and discharge characteristics, and cycles stably without being short-circuited.

### Embodiment 3

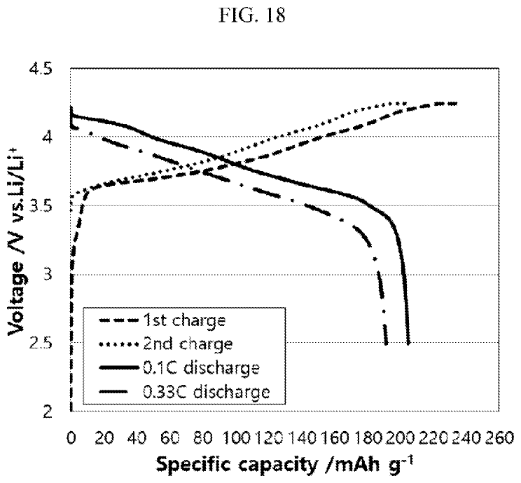

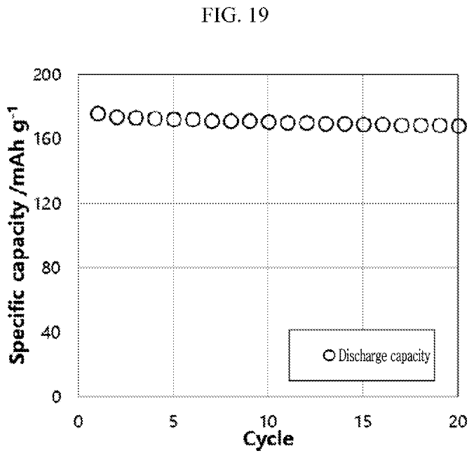

A stacked all-solid-state rechargeable battery in which two items of the all-solid-state rechargeable battery produced in Embodiment 1 are stacked is produced, and the charge and discharge test and the cycle test were performed under the same condition as in Embodiment 1. The result is represented in FIG. 18 and FIG. 19.

From the results of FIG. 18 and FIG. 19, it was confirmed that the stacked all-solid-state rechargeable battery produced in Embodiment 3 represents good charge and discharge characteristics, and it is cycling stably without being short-circuited.

### Comparative Example 1

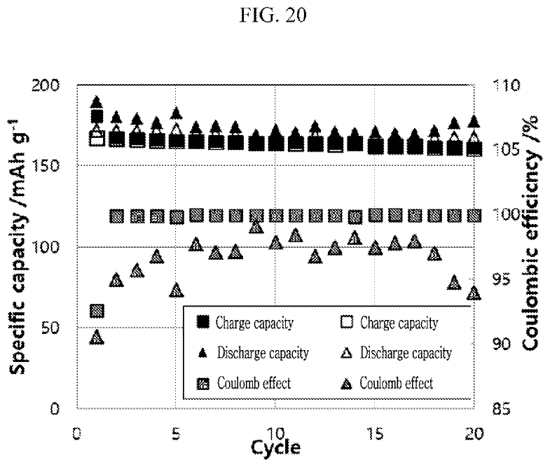

By using the insulative resin film as listed in Entry 6 of Table 1, the all-solid-state rechargeable battery was produced the same as in Embodiment 1, except that the positive electrode current collector of the same size as the punched positive electrode sheet is used such that the outer edge of the portion of the positive electrode current collector excluding the positive electrode current collecting portion may match the outer edge of the positive active material layer, and the cycle test were performed under the same condition as in Embodiment 1. The result is represented in FIG. 20. As shown in FIG. 20, there were quite a few instances where it represented defective cell characteristics, although there were cases that represented good cell characteristics.

### Comparative Example 2

Except for using the insulative resin film from Entry 7 of Table 1, an all-solid-state rechargeable battery was produced in the same way as Embodiment 2, and due to the voltage defect immediately after production, it was impossible to perform a charge and discharge test. In the case that the outer edge of the positive electrode current collector interposing the insulating layer may not be confirmed from the outside, a problem may arise where it is difficult to identify defects such as cracks or fractures in the current collecting film or misalignment with the electrode member that occur during the manufacturing process inside the cell.

From the results of these embodiments and Comparative Examples, in the case of Embodiments 1 to 3 where the total light transmittance of the insulating layer was 25% or more, no abnormalities were observed in the charge and discharge test and the cycle test, in almost all all-solid-state rechargeable batteries and stacked all-solid-state rechargeable batteries. Meanwhile, in the case of Comparative Example where the total light transmittance of the insulating layer is less than 25%, certain issues are generated in the all-solid-state rechargeable battery and the stacked all-solid-state rechargeable battery.

From the results, it was confirmed that by setting the total light transmittance of the insulating layer to 25% or more, and by making the position of the outer edge of the positive electrode current collector optically identifiable interposing the insulating layer, it was possible to further reduce the problems of the all-solid-state rechargeable battery and the stacked all-solid-state rechargeable battery, compared to the conventional art.

### DESCRIPTION OF SYMBOLS

1: all-solid-state rechargeable battery
10: positive electrode layer
11: positive electrode current collector
111: positive electrode current collecting portion
12: the positive active material layer
13: insulating layer
20: negative electrode layer
21: negative electrode current collector
211: negative electrode current collecting portion
22: the negative active material layer
30: solid electrolyte layer

1. An all-solid-state rechargeable battery, comprising:
a positive electrode layer;
a negative electrode layer;
a solid electrolyte layer disposed therebetween; and
an insulating layer configured to suppress short-circuiting caused by contact between the positive electrode layer and the negative electrode layer,
wherein the solid electrolyte layer is stacked on both surfaces of the positive electrode layer, respectively,
wherein the negative electrode layer is stacked on a surface of the respective solid electrolyte layer on an opposite side to the positive electrode layer, respectively, wherein the insulating layer is disposed on a side cross-section of the positive electrode layer to cover the positive electrode layer,
wherein the positive electrode layer comprises a thin positive electrode current collector and a positive active material layer stacked on both surfaces of the positive electrode current collector, respectively, and
wherein the insulating layer enables a position of an outer edge of the positive electrode current collector covered by the insulating layer to be optically identifiable through the insulating layer.

2. The all-solid-state rechargeable battery of claim 1, wherein a total light transmittance of the insulating layer is 25% or more and less than 100%.

3. The all-solid-state rechargeable battery of claim 1, wherein a linear light transmittance of the insulating layer at at least one wavelength within a wavelength range of 400 nm or more and 800 nm or less is 20% or more and less than 100% of a value calculated based on an insulating layer thickness of 100 μm.

4. The all-solid-state rechargeable battery of claim 1, wherein at least a portion of the outer edge of the positive electrode current collector protrudes outward beyond a side cross-section of the positive active material layer.

5. The all-solid-state rechargeable battery of claim 1, wherein the insulating layer contains a resin, and has a volume resistivity of 10¹² Ω/cm or more.

6. The all-solid-state rechargeable battery of claim 5, wherein the insulating layer further contains an insulative filler.

7. The all-solid-state rechargeable battery of claim 6, wherein the insulative filler is made of one or more materials selected from a group consisting of fibrous resin, resin non-woven fabric, alumina, magnesium oxide, silica, boehmite, barium titanate, carbonate barium, yttrium oxide and manganese oxide.

8. The all-solid-state rechargeable battery of claim 4, wherein:
the positive electrode current collector is provided with a positive electrode current collecting portion to be electrically connected to an external wire;
the positive electrode current collecting portion is installed to laterally protrude along a surface of the positive electrode current collector; and
a part or all of an outer edge of the insulating layer in the protruding direction of the positive electrode current collecting portion is located on an outer side of an outer edge of the negative electrode layer.

9. The all-solid-state rechargeable battery of claim 8, wherein a part or all of the outer edge of the negative electrode layer is disposed on the insulating layer.

10. The all-solid-state rechargeable battery of claim 1, wherein the solid electrolyte layer contains a sulfide-based solid electrolyte containing at least lithium, phosphorus, and sulfur.

11. The all-solid-state rechargeable battery of claim 1, wherein the negative electrode layer comprises a negative active material forming an alloy with lithium and/or a negative active material forming a compound with lithium, metal lithium may precipitate inside the negative electrode layer during charging, and 80% or more of a charge capacity of the negative electrode layer is exerted by metal lithium.

12. The all-solid-state rechargeable battery of claim 1, wherein the negative electrode layer comprises one type or more selected from a group consisting of amorphous carbon, gold, platinum, palladium, silicon, silver, aluminum, bismuth, tin and zinc.

13. A stacked all-solid-state rechargeable battery, comprising the all-solid-state rechargeable batteries of claim 1 is stacked by two or more quantity.
